(19) United States
(12) Patent Application Publication
(10) Pub. No.: US 2014/0059868 A1
(43) Pub. Date: Mar. 6, 2014

(54) POWER-TOOL SYSTEM

(71) Applicant: Robert Bosch GmbH, Stuttgart (DE)

(72) Inventors: Uwe Engelfried, Ostfildern (DE); Rudolf Fuchs, Neuhausen (DE)

(73) Assignee: Robert Bosch GmbH, Stuttgart (DE)

(21) Appl. No.: 13/975,613

(22) Filed: Aug. 26, 2013

(30) Foreign Application Priority Data
Aug. 31, 2012 (DE) 10 2012 215 455.8

(51) Int. Cl. B23D 57/02

(52) U.S. Cl. CPC B23D 57/023
USPC 30/381

(57) ABSTRACT

A power-tool system has at least one power-tool parting device which includes at least one cutting strand and at least one guide unit. The power-tool system also has at least one portable power tool, which includes at least one coupling device, configured to couple the power-tool parting device, and at least one through-grip main handle. The at least one through-grip main handle includes at least one handle longitudinal axis which extends at least substantially transversely in relation to a longitudinal axis of the at least one guide unit, at least when the power-tool parting device is disposed on the at least one coupling device.

This application claims priority under 35 U.S.C. §119 to patent application no. DE 10 2102 215 455.8, filed on Aug. 31, 2012 in Germany, the disclosure of which is incorporated herein by reference in its entirety.

### BACKGROUND

There are already known power-tool systems that have a power-tool parting device, comprising a cutting strand and a guide unit, and a portable power tool that comprises a coupling device, for coupling the power-tool parting device, and a through-grip main handle.

### SUMMARY

The disclosure is based on a power-tool system having at least one power-tool parting device, comprising at least one cutting strand and at least one guide unit, and having at least one portable power tool that comprises at least one coupling device, for coupling the power-tool parting device, and at least one through-grip main handle.

It is proposed that the through-grip main handle comprise at least one handle longitudinal axis, which extends at least substantially transversely in relation to a longitudinal axis of the guide unit, at least when the power-tool parting device is disposed on the coupling device. A “cutting strand” is intended here to mean, in particular, a unit provided to locally undo an atomic coherence of a workpiece to be worked, in particular by means of a mechanical parting-off and/or by means of a mechanical removal of material particles of the workpiece. Preferably, the cutting strand is provided to separate the workpiece into at least two parts that are physically separate from each other, and/or to part off and/or remove, at least partially, material particles of the workpiece, starting from a surface of the workpiece. Particularly advantageously, cutting gaps of small dimensions can be produced, in that the cutting strand, as viewed along the direction running substantially perpendicularly in relation to the cutting plane of the cutting strand, has a maximum dimension of between 1.3 mm and 2.2 mm. Particularly preferably, the cutting strand, in at least one operating state, is moved in a revolving manner, in particular along a circumference of the guide unit. A “guide unit” is to be understood here to mean, in particular, a unit provided to exert a constraining force upon the cutting strand, at least along a direction perpendicular to a cutting direction of the cutting strand, in order to define a possibility for motion of the cutting strand along the cutting direction. In this context, “provided” is intended to mean, in particular, specially configured and/or specially equipped. Preferably, the guide unit has at least one guide element, in particular a guide groove, by which the cutting strand is guided. Preferably, the cutting strand, as viewed in a cutting plane, is guided by the guide unit along an entire circumference of the guide unit, by means of the guide element, in particular the guide groove. Preferably the guide unit, together with the mounted cutting strand, has a maximum dimension of less than 50 mm, as viewed along a direction running at least substantially parallelwise in relation to the cutting plane of the cutting strand and at least substantially perpendicularly in relation to a direction of main extent of the guide unit.

The term “cutting plane” is intended here to define, in particular, a plane in which the cutting strand, in at least one operating state, is moved along a circumference of the guide unit, in at least two mutually opposite cutting directions, relative to the guide unit. Preferably, during working of a workpiece, the cutting plane is aligned at least substantially transversely in relation to a workpiece surface to be worked. “At least substantially transversely” is intended here to mean, in particular, an alignment of a plane and/or a direction, relative to a further plane and/or a further direction, that is preferably other than a parallel alignment of the plane and/or the direction relative to the further plane and/or the further direction. It is also conceivable, however, for the cutting plane, during working of a workpiece, to be aligned at least substantially parallelwise in relation to a workpiece surface to be worked, in particular if the cutting strand is realized as an abrasive means, etc. “At least substantially parallelwise” is intended here to mean, in particular, an alignment of a direction relative to a reference direction, in particular in one plane, the direction deviating from the reference direction by, in particular, less than 8°, advantageously less than 5°, and particularly advantageously less than 2°. A “cutting direction” is to be understood here to mean, in particular, a direction along which the cutting strand is moved for the purpose of producing a cutting gap and/or parting-off and/or removing material particles of a workpiece to be worked, in at least one operating state, as a result of a driving force and/or a driving torque, in particular in the guide unit. Preferably, the cutting strand, when in an operating state, is moved along the cutting direction, relative to the guide unit.

Preferably, the guide unit and the cutting strand together constitute a closed system. The term “closed system” is intended here to define, in particular, a system comprising at least two components that, by means of combined action, when the system has been demounted from a system such as, for example, a power tool, that is of a higher order than the system, maintain a functionality and/or are captively connected to each other when in the demounted state. Preferably, the at least two components of the closed system are connected to each other so as to be at least substantially inseparable by an operator. “At least substantially inseparable” is to be understood here to mean, in particular, a connection of at least two components that can be separated from each other only with the aid of parting tools such as, for example, a saw, in particular a mechanical saw, etc. and/or chemical parting means such as, for example, solvents.

A “portable power tool” is to be understood here to be, in particular, a power tool, in particular a hand-held power tool, that can be transported by an operator without a transport machine. The portable power tool has, in particular, a mass of less than 40 kg, preferably less than 10 kg, and particularly preferably less than 5 kg. Particularly preferably, the portable power tool is realized differently from a chainsaw. A “coupling device” is to be understood here to mean, in particular, a device provided to operatively connect the power-tool parting device to the portable power tool, by means of a positive and/or non-positive connection, for the purpose of working a workpiece. In particular, when the coupling device has been coupled to the power-tool parting device and the portable power tool is in an operating state, forces and/or torques can be transmitted from the drive unit of the portable power tool to the power-tool parting device, for the purpose of driving the cutting strand. The coupling device is therefore preferably realized as a tool receiver. Preferably, the portable power tool comprises at least one drive unit for driving the power-tool parting device when disposed on the coupling device. The term “drive unit” is intended here to define, in particular, a unit provided to generate forces and/or torques for driving the cutting strand. Preferably, for the purpose of generating forces and/or torques by means of the drive unit, thermal energy, chemical energy and/or electrical energy is converted into energy of motion. In particular, the drive unit is realized such that it can be directly and/or indirectly coupled to the cutting strand. Particularly preferably, the drive unit comprises at least one stator, and at least one rotor that has an armature shaft. The drive unit is thus realized, in particular, as an electric motor.

The term “through-grip main handle” is intended here to define, in particular, a main handle of the portable power tool that, as viewed in a plane, completely surrounds a through-grip recess for a hand or fingers of an operator. Preferably, the through-grip main handle is realized as a D-type handle. The term “longitudinal axis” is intended here to define, in particular, an axis along which a component, in particular the guide unit, has a maximum dimension. A “handle longitudinal axis” is to be understood here to mean, in particular, an axis of the through-grip main handle along which a main extent of a main grip element of the through-grip main handle extends, wherein an operator, in particular, grasps the main grip element of the through-grip main handle for the purpose of properly handling the portable power tool. When the main grip element of the through-grip main handle is grasped, at least partial regions of fingers are disposed in the through-grip recess that is delimited by the through-grip main handle. Particularly preferably, at least one operating element of an operating unit of the portable power tool is disposed on the main grip element, for the purpose of starting up the portable power tool, or interrupting an electrical power supply to the drive unit. A compact power tool can be achieved, advantageously, by means of the configuration of the power-tool system according to the disclosure. Comfortable working of workpieces is thus made possible.

Furthermore, it is proposed that the handle longitudinal axis of the through-grip main handle extend at least substantially perpendicularly in relation to the longitudinal axis of the guide unit, at least when the power-tool parting device is disposed on the coupling device. The expression “substantially perpendicularly” is intended here to define, in particular, an alignment of a direction relative to a reference direction, the direction and the relative direction, in particular as viewed in one plane, enclosing an angle of 90° and the angle having a maximum deviation of, in particular, less than 8°, advantageously less than 5°, and particularly advantageously less than 2°. In this case, the longitudinal axis of the guide unit and the handle longitudinal axis of the through-grip main handle extend, particularly preferably, in a common plane. “Extending at least substantially in a common plane” is to be understood here to mean, in particular, a disposition of the handle longitudinal axis and of the longitudinal axis such that the handle longitudinal axis and the longitudinal axis, in at least one region, have a distance of less than 15 mm, preferably less than 10 mm, and particularly preferably less than 5 mm and, in particular, intersect in at least one point. Preferably, the handle longitudinal axis and the longitudinal axis span the common plane. Advantageously, a small overall structural length of the portable power tool can be realized.

Further, it is proposed that the portable power tool comprise at least one power-tool housing, the through-grip main handle being disposed on the power-tool housing, on a side of the power-tool housing that faces away from the coupling device. It is also conceivable, however, for the through-grip main handle to be disposed at another position on the power-tool housing, considered appropriate by persons skilled in the art, such as, for example, in a region of the power-tool housing disposed at a distance of less than 5 mm from the coupling device. Precise guidance of the power-tool parting device during working of a workpiece can be achieved, advantageously, by means of the configuration according to the disclosure.

In addition, it is proposed that the portable power tool comprise at least one power-tool housing, the through-grip main handle being realized so as to be integral with the power-tool housing. “Integral with” is to be understood to mean, in particular, connected at least in a materially bonded manner, for example by a welding process, an adhesive process, an injection process and/or another process considered appropriate by persons skilled in the art, and/or, advantageously, formed in one piece such as, for example, by being produced from a casting and/or by being produced in a single or multi-component injection process and, advantageously, from a single blank. Advantageously, savings can be made in respect of assembly work and costs. In addition, advantageously, the through-grip main handle can be connected to the power-tool housing in a stable manner.

Further, it is proposed that the portable power tool comprise at least one power-tool housing, and at least one damping unit that is provided to connect the through-grip main handle to the power-tool housing in a vibration-damped manner. A “damping unit” is to be understood here to mean, in particular, a unit specifically provided to convert vibrations, or oscillations, in the form of energy of motion, into thermal energy, and thus to reduce, or damp, a transmission of vibration between the power-tool housing and the through-grip main handle. The term “provided” is intended here to define, in particular, specially equipped and/or specially configured and/or specially programmed. The damping unit preferably comprises at least one damping element. The damping element preferably has a modulus of elasticity that is less than 500 N/mm², preferably less than 100 N/mm², and particularly less than 50 N/mm². The damping element is elastically compressible, in particular, by more than 0.1 mm, preferably by more than 0.5 mm, and particularly preferably by more than 1 mm. By means of the configuration according to the disclosure, advantageously, a transmission of vibration, going from the drive unit to the through-grip main handle, can be damped. Advantageously, therefore, workpieces can be worked in a manner that is sparing of stress upon the operator.

Furthermore, the disclosure is based on a power-tool parting device of a power-tool system according to the disclosure. Advantageously, an efficient insert tool, for use in a variety of already existing power tools, can be created.

In addition, the disclosure is based on a portable power tool of a power-tool system according to the disclosure. The portable power tool can be realized as a cable-bound or as a battery-operated, portable power tool. Advantageously, a power tool having a high degree of operator comfort can be realized.

The power-tool system according to the disclosure, the power-tool parting device according to the disclosure and/or the power tool according to the disclosure is/are not intended in this case to be limited to the application and embodiment described above. In particular, the power-tool system according to the disclosure, the power-tool parting device according to the disclosure and/or the power tool according to the disclosure, for the purpose of implementing a mode of functioning described herein, can have a number of individual elements, components and units that differs from a number stated herein.

### BRIEF DESCRIPTION OF THE DRAWINGS

Further advantages are given by the following description of the drawing. The drawing shows exemplary embodiments of the disclosure. The drawing and the description contain numerous features in combination. Persons skilled in the art will also expediently consider the features individually and combine them to create appropriate further combinations.

In the drawing:

FIG. 1 shows a power-tool system according to the disclosure having a power tool according to the disclosure and having a power-tool parting device according to the disclosure, in a schematic representation, and

FIG. 2 shows an alternative power-tool system according to the disclosure having a power tool according to the disclosure and having a power-tool parting device according to the disclosure, in a schematic representation.

### DETAILED DESCRIPTION

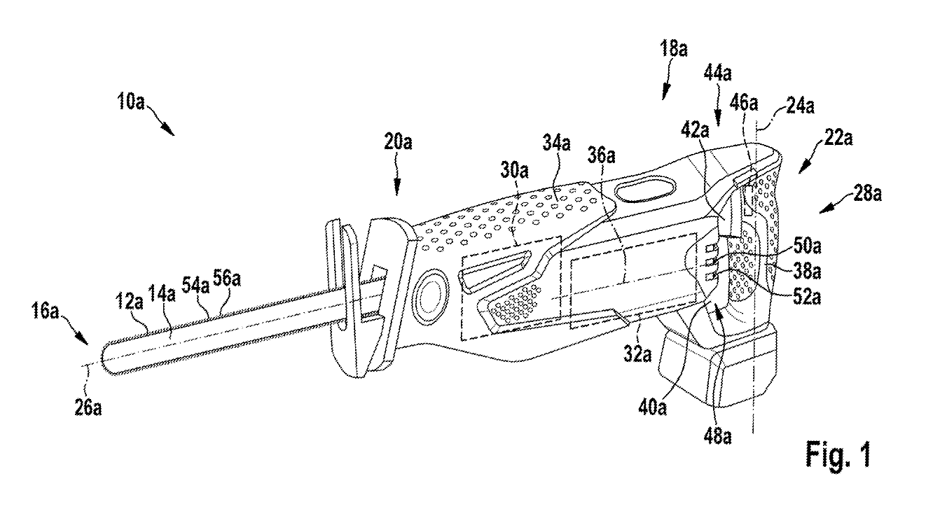

FIG. 1 shows a power-tool system 10a having at least one power-tool parting device 16a that comprises at least one cutting strand 12a and at least one guide unit 14a, and having at least one portable power tool 18a, which comprises at least one coupling device 20a, for coupling the power-tool parting device 16a, and at least one through-grip main handle 22a. The portable power tool 18a additionally comprises a transmission unit 30a, and at least one drive unit 32a for driving the power-tool parting device 16a when disposed on the coupling device 20a. The coupling device 20a is provided to couple the power-tool parting device 16a to the portable power tool 18a in a positive and/or non-positive manner. The coupling device 20a in this case can be realized as a bayonet closure and/or as another coupling device considered appropriate by persons skilled in the art.

Furthermore, the portable power tool 18a has a power-tool housing 34a, which encloses the drive unit 32a and the transmission unit 30a of the portable power tool 18a, and which supports bearing forces of the drive unit 32a and the transmission unit 30a. The drive unit 32a has a drive-unit longitudinal axis 36a, which extends at least substantially transversely in relation to a handle longitudinal axis 24a of the through-grip main handle 22a. The drive-unit longitudinal axis 36a of the drive unit 32a in this case extends at least substantially perpendicularly in relation to the handle longitudinal axis 24a of the through-grip main handle 22a. In addition, the handle longitudinal axis 24a of the through-grip main handle 22a extends at least substantially transversely in relation to a longitudinal axis 26a of the guide unit 14a, at least when the power-tool parting device 16a is disposed on the coupling device 20a. The through-grip main handle 22a thus has at least the handle longitudinal axis 24a, which extends at least substantially transversely in relation to the longitudinal axis 26a of the guide unit 14a, at least when the power-tool parting device 16a is disposed on the coupling device 20a. The handle longitudinal axis 24a of the through-grip main handle 22a in this case extends at least substantially perpendicularly in relation to the longitudinal axis 26a of the guide unit 14a, at least when the power-tool parting device 16a is disposed on the coupling device 20a. When the power-tool parting device 16a is disposed on the coupling device 20a, therefore, the longitudinal axis 26a of the guide unit 14a extends at least substantially parallelwise in relation to the drive-unit longitudinal axis 36a of the drive unit 32a. The drive-unit longitudinal axis 36a of the drive unit 32a is constituted by a rotation axis of an armature shaft (not represented in greater detail here) of the drive unit 32a, which is realized as an electric motor unit. In this case, the drive-unit longitudinal axis 36a of the drive unit 32a, the handle longitudinal axis 24a of the through-grip main handle 22a and the longitudinal axis 26a of the guide unit 14a are together disposed in a common plane, or span the common plane, when the power-tool parting device 16a is disposed on the coupling device 20a.

The handle longitudinal axis 24a of the through-grip main handle 22a extends at least substantially parallelwise in relation to a main extent of a main handle element 38a of the through-grip main handle 22a. The main handle element 38a thus extends substantially perpendicularly in relation to the drive-unit longitudinal axis 36a of the drive unit 32a. For the purpose of proper handling of the portable power tool 18a, the main handle element 38a of the through-grip main handle 22a is grasped by an operator's hand. When the main handle element 38a of the through-grip main handle 22a is grasped, at least partial regions of fingers are disposed in a through-grip recess 40a of the through-grip main handle 22a. The through-grip recess 40a is delimited completely by the through-grip main handle 22a in a plane that extends at least substantially parallelwise in relation to the common plane. At least one operating element 42a of an operating unit 44a of the portable power tool 18a is disposed on the main handle element 38a. The operating unit 44a is provided to interrupt and/or to establish an electric power supply to the drive unit 32a, by means of an electrical and/or mechanical switch element 46a of the operating unit 44a, as a result of an actuation of the operating element 42a. The operating element 42a in this case is realized as a pressure-switch operating element, which acts upon the switch element 46a. It is also conceivable, however, for the operating element 42a to be of another configuration, considered appropriate by persons skilled in the art, such as, for example, being configured as a toggle-switch operating element, a rotary-switch operating element, etc.

The through-grip main handle 22a is disposed on the power-tool housing 34a, on a side 28a of the power-tool housing 34a that faces away from the coupling device 20a. The through-grip main handle 22a in this case is realized so as to be integral with the power-tool housing 34a. In addition, ventilation openings 50a, 52a of the portable power tool 18a, for discharging heat from the drive unit 32a, are disposed on a housing connection region 48a of the through-grip main handle 22a that is opposite the main handle element 38a, as viewed along the drive-unit longitudinal axis 36a of the drive unit 32a. The through-grip main handle 22a is integrally formed on to the power-tool housing 34a, by means of the housing connection region 48a.

The drive unit 32a and the transmission unit 30a are operatively connected to each other, in a manner already known to persons skilled in the art, for the purpose of generating a driving torque that can be transmitted to the power-tool parting device 16a. The transmission unit 30a is realized as an angle-gear transmission, such as, for example, a worm gear transmission, bevel gear transmission, spur gear transmission, etc. The drive unit 32a is provided to drive the cutting strand 12a of the power-tool parting device 16a via the transmission unit 30a. The cutting strand 12a and the guide unit 14a of the power-tool parting device 16a together constitute a closed system. The cutting strand 12a is guided by means of the guide unit 14a. For this purpose, the guide unit 14a has at least one guide groove (not represented in greater detail here). The cutting strand 12a is guided by means of edge regions of the guide unit 14a that delimit the guide groove. It is also conceivable, however, for the guide unit 14a to have another element, considered appropriate by persons skilled in the art, for guiding the cutting strand 12a, such as, for example, an element that is realized as a rib-type element formed on to the guide unit 14a and that engages in a recess on the cutting strand 12a. During operation, the cutting strand 12a is moved in a revolving manner along a circumference of the guide unit 14a, in the guide groove. The cutting strand 12a is realized as a cutting chain. For this purpose, the cutting strand 12a has a multiplicity of cutting strand segments 54a, 56a that are connected to each other.

When the power-tool parting device 16a is disposed on the coupling device 20a, an output element (not represented in greater detail here), realized as a toothed wheel, of the transmission unit 30a engages in the guide unit 14a. In this case, for the purpose of driving the cutting strand 12a, the output element is temporarily in engagement with the cutting-strand segments 54a, 56a of the cutting strand 12a. The output element is fastened in a rotationally fixed manner, by means of a positive and/or non-positive connection, on an output shaft (not represented in greater detail here) of the transmission unit 30a. It is also conceivable, however, for the output element to be realized so as to be integral with the output shaft.

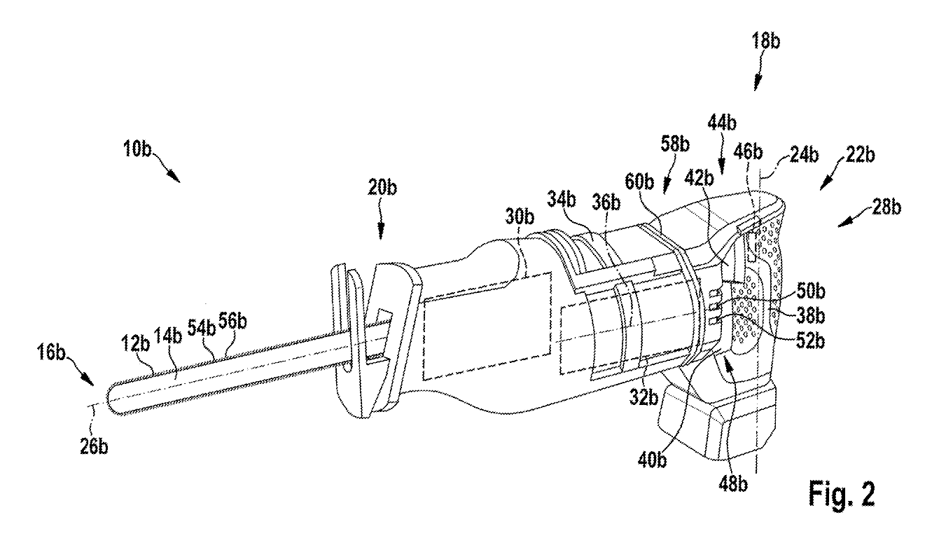

An alternative exemplary embodiment is represented in FIG. 2. Components, features and functions that remain substantially the same are denoted by essentially the same references. To differentiate the exemplary embodiments, the letters a and b are appended to the references of the exemplary embodiments. The description that follows is limited essentially to the differences in respect of the first exemplary embodiment, described in FIG. 1, and reference may be made to the description of the first exemplary embodiment of FIG. 1 in respect of components, features and functions that remain the same.

FIG. 2 shows a power-tool system 10b having at least one power-tool parting device 16b that comprises at least one cutting strand 12b and at least one guide unit 14b, and having at least one portable power tool 18b, which comprises at least one coupling device 20b, for coupling the power-tool parting device 16b, and at least one through-grip main handle 22b. The portable power tool 18b additionally comprises a transmission unit 30b, and at least one drive unit 32b for driving the power-tool parting device 16b when disposed on the coupling device 20b. The coupling device 20b is provided to couple the power-tool parting device 16b to the portable power tool 18b in a positive and/or non-positive manner. The coupling device 20b in this case can be realized as a bayonet closure and/or as another coupling device considered appropriate by persons skilled in the art.

Furthermore, the through-grip main handle 22b comprises at least one handle longitudinal axis 24b, which extends substantially transversely in relation to a longitudinal axis 26b of the guide unit 14b, at least when the power-tool parting device 16b is disposed on the coupling device 20b. The difference between the portable power tool 18b from FIG. 2 and the portable power tool 18a from FIG. 1 consists in the connection of the through-grip main handle 22b to a power-tool housing 34b of the portable power tool 18b. The through-grip main handle 22b is fastened to the power-tool housing 34b by means of a damping unit 58b of the portable power tool 18b. In this case, the damping unit 58b has an annular damping element 60b. The damping element 60b extends along a full circumference of the power-tool housing 34b that extends around a drive-unit longitudinal axis 36b of a drive unit 32b of the portable power tool 18b. The damping element 60b is provided to fasten the through-grip main handle 22b to the power-tool housing 34b in a vibration-damped manner. For this purpose, the damping element 60b is composed of an elastomer. It is also conceivable, however, for the damping element 60b to be composed of another vibration-damping material considered appropriate by persons skilled in the art. The damping element 60b is fastened to a housing connection region 48b of the through-grip main handle 22b in a non-positive, materially bonded and/or positive manner. The damping element 60b is fastened to the power-tool housing 34b in a non-positive, materially bonded and/or positive manner by an end that faces away from the housing connection region 48b. In respect of further features of the portable power tool 18b, reference may be made to the description of the portable power tool 18a from FIG. 1.

What is claimed is:

1. A power-tool system comprising:
at least one power-tool parting device, including at least one cutting strand and at least one guide unit; and
at least one portable power tool, including at least one coupling device, configured to couple the at least one power-tool parting device, and including at least one through-grip main handle,
wherein the at least one through-grip main handle includes at least one handle longitudinal axis configured to extend at least substantially transversely in relation to a longitudinal axis of the at least one guide unit, at least when the at least one power-tool parting device is disposed on the at least one coupling device.

2. The power-tool system according to claim 1, wherein the at least one handle longitudinal axis of the at least one through-grip main handle is configured to extend at least substantially perpendicularly in relation to the longitudinal axis of the at least one guide unit, at least when the at least one power-tool parting device is disposed on the at least one coupling device.

3. The power-tool system according to claim 1, wherein:
the at least one portable power tool includes at least one power-tool housing, and
the at least one through-grip main handle is disposed on the at least one power-tool housing on a side of the at least one power-tool housing that faces away from the at least one coupling device.

4. The power-tool system according to claim 1, wherein:
the at least one portable power tool includes at least one power-tool housing, and
the at least one through-grip main handle is configured so as to be integral with the at least one power-tool housing.

5. The power-tool system according to claim 1, wherein:
the at least one portable power tool includes at least one power-tool housing and at least one damping unit configured to connect the at least one through-grip main handle to the at least one power-tool housing in a vibration-damped manner.

6. A power-tool parting device of a power-tool system, the power-tool parting device comprising:
at least one cutting strand and at least one guide unit which together constitute a closed system,
wherein at least one portable power tool includes at least one coupling device configured to couple the power-tool parting device, and
wherein at least one through-grip main handle of the at least one portable power tool includes at least one handle longitudinal axis configured to extend at least substantially transversely in relation to a longitudinal axis of the at least one guide unit, at least when the power-tool parting device is disposed on the at least one coupling device.

7. A portable power tool of a power-tool system, the portable power tool comprising:
at least one coupling device configured to couple at least one power-tool parting device and including at least one through-grip main handle,
wherein the at least one through-grip main handle includes at least one handle longitudinal axis configured to extend at least substantially transversely in relation to a longitudinal axis of at least one guide unit of the at least one power-tool parting device, at least when the at least one power-tool parting device is disposed on the at least one coupling device.
